(19) United States
(12) Patent Application Publication
(10) Pub. No.: US 2016/0092829 A1
(43) Pub. Date: Mar. 31, 2016

(54) CONSIGNED INVENTORY MANAGEMENT SYSTEM

(71) Applicant: Oracle International Corporation, Redwood Shores, CA (US)

(72) Inventors: Matthew Michael JONES, Burlingame, CA (US); Manju Omprakash JUNEJA, Belmont, CA (US); Karthik GNANAMURTHY, Foster City, CA (US); Kalasagar KANDIKUPPA, Secunderabad (IN); Jason Yun Wei SHEU, Redwood City, CA (US); William Edwin Rudge, V, San Jose, CA (US); Govinda Rao HADAGALI, Hyderabad (IN); Saket Sharan RAWAT, Hyderabad (IN); Vishal BERRY, Hyderabad (IN); Deepak AGRAWAL, Hyderabad (IN); Padmapriya PARTHASARATHY, Cupertino, CA (US); PavanKumar Annapragada Naga VENKATA, Hyderabad (IN); Kathleen Mary GAHAN, Clawson, MI (US); Maneesh KUMAR, Fremont, CA (US); Susan Elizabeth FLIERL, Portola Valley, CA (US)

(21) Appl. No.: 14/499,372

(22) Filed: Sep. 29, 2014

(51) Int. Cl. G06Q 10/08

(52) U.S. Cl. CPC G06Q 10/087

(57) ABSTRACT

A system is provided that manages consigned inventory. The system consumes consigned inventory items. The system further generates a consumption advice in response to the consumption of the consigned inventory items, where the consumption advice references a consignment agreement, a consignment order and a receipt. The system further communicates the consumption advice to a supplier. The consumption advice includes at least one of: a consumption advice number; a business unit; an inventory organization; a supplier; a supplier site; a start date; or an end date. The consumption advice includes one or more consumption advice lines, and each consumption advice line includes one or more consumption transactions.

### FIELD

One embodiment is directed to a computer system, and more particularly, to a computer system that facilitates procurement.

### BACKGROUND

“Consigned inventory” is an inventory of items or services that is in the possession of a buyer (e.g., a customer, a contract manufacturer, etc.) but still owned by a seller (e.g., a supplier, a manufacturer, etc.). In other words, the seller places some of their inventory in the buyer's possession (e.g., in the buyer's store or warehouse), and allows the buyer to consume directly from the seller's inventory. The buyer purchases the inventory from the seller only when the inventory is consumed. For example, Buyer A issues an order for 1,000 items of widget X. Seller B receives the order and ships 1,000 items of widget X to Buyer A. Buyer A receives the 1,000 items of widget X and places the 1,000 items in consigned inventory. Although Buyer A takes physical possession of the 1,000 items of widget X, ownership of liability for the 1,000 items remains with Seller B. Buyer A subsequently withdraws 10 items from the consigned inventory of 1,000 items of widget X. Buyer A pays Seller B for the 10 items of widget X, and assumes ownership of liability for the 10 items.

A consigned inventory model is generally used in scenarios where the buyer would not stock certain items due to working capital constraints or demand uncertainty. In such scenarios, consigned inventory can allow the seller to provide a higher service level (by having the items immediately available), save expedited freight costs, and ensure the buyer does not procure the items from a competitor. The buyer benefits by reducing its investment in inventory and improving its working capital balance.

### SUMMARY

One embodiment is a system that manages consigned inventory. The system consumes consigned inventory items. The system further generates a consumption advice in response to the consumption of the consigned inventory items, where the consumption advice references a consignment agreement, a consignment order and a receipt. The system further communicates the consumption advice to a supplier. The consumption advice includes at least one of: a consumption advice number; a business unit; an inventory organization; a supplier; a supplier site; a start date; or an end date. The consumption advice includes one or more consumption advice lines, and each consumption advice line includes one or more consumption transactions.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates a consigned inventory process flow.

FIG. 3 illustrates a flow diagram of the functionality of a consigned inventory management module for transferring consigned inventory from one location to another location, according to an embodiment of the invention.

FIG. 4 illustrates a table that includes “transfer to owned” transactions and corresponding “transfer to consigned” transactions, according to an embodiment of the invention.

FIG. 5 illustrates a flow diagram of the functionality of a consigned inventory management module for returning goods to a consigned status, according to another embodiment of the invention.

FIG. 6 illustrates an example user interface that displays one or more consumption advices, according to an embodiment of the invention.

FIG. 7 illustrates a flow diagram of the functionality of a consigned inventory management module for consumption advice generation, according to another embodiment of the invention.

FIG. 8 illustrates a flow diagram of a consigned inventory return process flow, according to an embodiment of the invention.

FIG. 9 illustrates a flow diagram of the functionality of a consigned inventory management module involving a consigned inventory return process flow, according to another embodiment of the invention.

FIG. 10 illustrates a table that includes inventory items where an ownership status is indicated, according to an embodiment of the invention.

FIG. 11 illustrates a flow diagram of the functionality of a consigned inventory management module for counting consigned inventory, according to another embodiment of the invention.

### DETAILED DESCRIPTION

According to an embodiment, a consigned inventory management system is provided that manages consigned inventory from a supplier. The consigned inventory management system can provide for a transfer of inventory between organizations while the inventory remains in a consigned status. The consigned inventory management system can further provide for an automatic transfer of owned inventory to a consigned status. The consigned inventory management system can further provide for an automatic generation and management of a consumption advice document. The consigned inventory management system can further provide for returning consigned inventory to a supplier at any point in a consignment process. The consigned inventory management system can further provide for identifying and recording an ownership status of inventory during a cycle and physical inventory count process.

The following terms are defined. “Consigned inventory” is inventory that is in possession of one party but that is owned by another party based on an agreement. “Consumption” is an act of consuming consigned inventory (where the term “consumption” can be used interchangeably with the term “ownership transfer”). “Consumption advice” is a document that can indicate consumed consigned inventory, where the document can be generated by a buyer, and where the document can be sent to a seller. “Consignment agreement” is an agreement for a purchase of inventory items under a consignment arrangement between the trading partners. A consignment agreement can define one or more consignment terms, one or more purchasing terms, and one or more pricing terms. A consignment agreement is not required to define delivery details, quantities, locations or dates for consigned inventory items to be delivered. Instead, those details can be defined on a consignment order issued against the consignment agreement.

“Consignment order” is an order that can use the consignment terms, purchasing terms, and pricing terms defined by a consignment agreement, and that further defines one or more delivery details, one or more delivery quantities, one or more delivery locations, and one or more delivery dates for consigned inventory items to be delivered. “Explicit consumption” is a consumption transaction that is explicitly triggered by a user, and is not triggered by any other inventory transaction. A user can explicitly trigger a consumption transaction by selecting an owning party whose consigned inventory items are to be transferred to using a user interface. “Implicit consumption” is a consumption transaction that occurs as a result of an inventory transaction, such as a sales order issue. Typically, a majority of consumption transactions occur as a result of implicit consumption. “Interorganization transfer” is a transfer of inventory items between two organizations. A “lot” is a quantity of inventory items that are produced together and share the same production costs and specifications.

“Owning party” is a party that owns inventory. When the inventory is consigned, it is owned by a seller (e.g., a supplier). Upon inventory consumption or usage, the owning party becomes the party that consumed or used the inventory. “Serial number” is a unique number assigned for identification to a single inventory item that is not repeated for similar inventory items. A “transfer to owned” transaction is an inventory transaction that transfers consigned inventory to owned inventory (i.e., that transfers inventory from a consigned status to an owned status). A “transfer to consigned” transaction is an inventory transaction that transfers owned inventory to consigned inventory (i.e., that transfers inventory from an owned status to a consigned status).

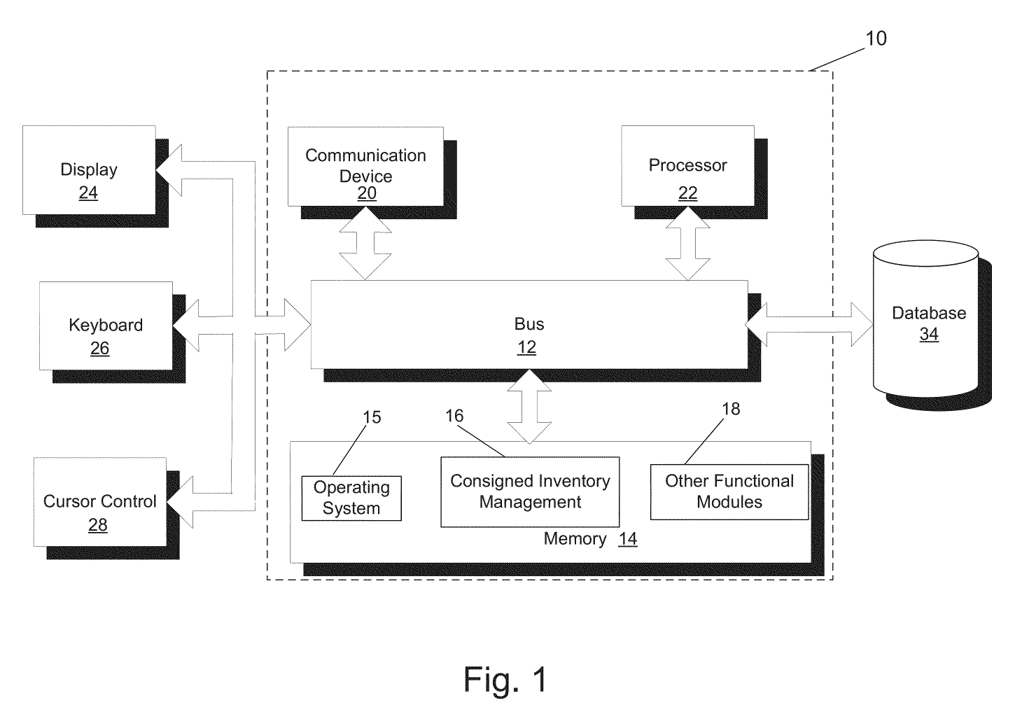

FIG. 1 illustrates a block diagram of a system 10, such as a consigned inventory management system, that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, a consigned inventory management module 16, as well as other functional modules 18. Operating system 15 can provide an operating system functionality for system 10. Consigned inventory management module 16 can provide functionality for managing consigned inventory. In certain embodiments, consigned inventory management module 16 can comprise a plurality of modules, where each module provides specific individual functionality for managing consigned inventory. System 10 can also be part of a larger system. Thus, system 10 can include one or more additional functional modules 18 to include the additional functionality. For example, functional modules 18 may include modules that provide additional functionality, such as functionality of an “Oracle Fusion Inventory Management” product by Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

As previously described, consigned inventory refers to an inventory of items or services that is in the possession of a buyer (e.g., a customer, a contract manufacturer, etc.) but still owned by a seller (e.g., a supplier, a manufacturer, etc.). In a business use case where the inventory is sold between two parties, a consignment agreement is typically used to defer the change in ownership past the arrival/acceptance of the inventory to a subsequent point in time that is mutually agreed upon by the two parties. A change in ownership typically occurs when the buyer uses the inventory (e.g., issues the inventory to manufacturing or sells the inventory to an end customer), or after a pre-specified time period (e.g., 30, 60, or 90 days). This time period is referred to as an aging period.

There can be several benefits to consigning inventory for both parties. For example, suppliers can compete on the basis of availability and delivery when finished inventory items are at the customer site, particularly when lead times are lengthy. Additionally, holding inventory on consignment can reduce lead times for inventory items that might be required to fill sales orders. Further, buyers can experience increased inventory without having to invest additional funds in inventory. Financial resources can be available until customer commitments are ensured, or inventory items are used in production.

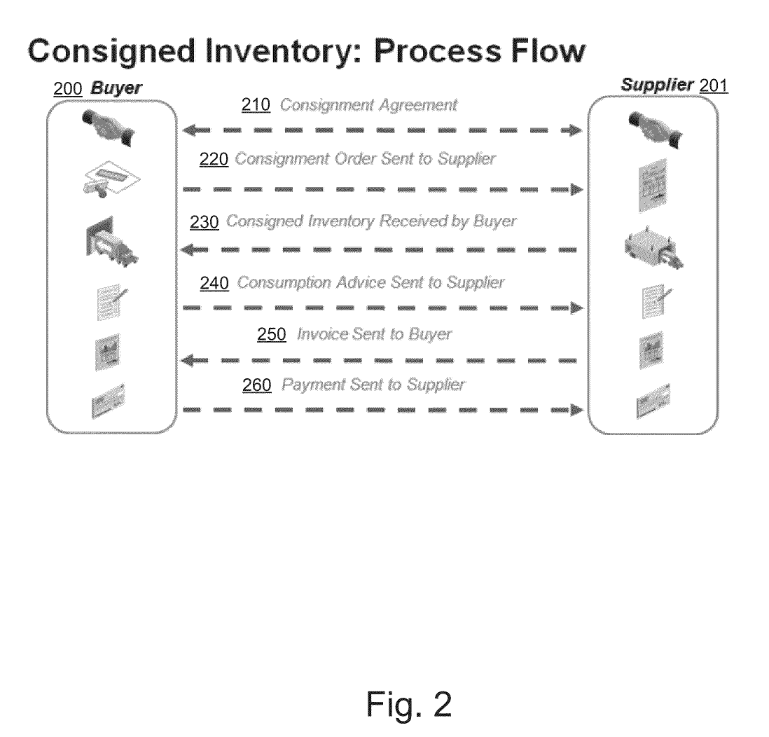

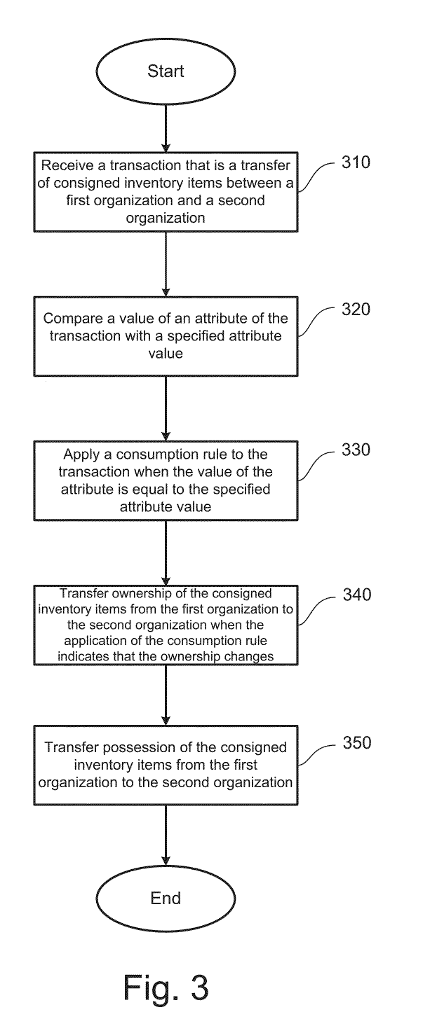

FIG. 2 illustrates a consigned inventory process flow. In one embodiment, the functionality of the flow diagram of FIG. 2, as well as the functionality of the flow diagram of FIGS. 3, 5, 7, 8, 9, and 11, are each implemented by software stored in a memory or some other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In certain embodiments, some of the functionality of the flow diagrams of FIGS. 2, 3, 5, 7, 8, 9, and 11 can be omitted.

At 210, the consigned inventory process starts with a buyer 200 entering into a consignment agreement with a supplier 201. The consignment agreement defines one or more consignment terms, one or more purchasing terms, and one or more pricing terms. Consignment terms are terms related to managing a consignment relationship between the buyer and the supplier. Examples of consignment terms include: an indication that consigned inventory items are purchased under a consignment arrangement, an aging period that specifies a period for which the consigned inventory items can be consigned before the consigned inventory items are considered purchased, a frequency for reporting consumption transactions via consumption advices, or a billing cycle for reporting consumption transactions via consumption advices, where the billing cycle includes a billing cycle opening date and a billing cycle closing date. Purchasing terms are terms related to a purchase of consigned inventory items. An example of a purchasing term is a consigned inventory item quantity threshold. Pricing terms are terms related to a price of consigned inventory items. An example of a pricing term is a price for a consigned inventory item. The flow then proceeds to 220.

At 220, buyer 200 generates a purchase order (i.e., a consignment order) requesting supplier 201 ship one or more consigned inventory items. The generation of a consignment order can occur on a periodic basis. The flow then proceeds to 230. At 230, buyer 200 receives the one or more consigned inventory items from supplier 201, and holds the consigned inventory items as consigned inventory, where the possession of the consigned inventory is with buyer 200, but the ownership of the consigned inventory remains with supplier 201. The change of ownership occurs when buyer 200 consumes the consigned inventory, or when the aging period expires. The flow then proceeds to 240.

At 240, once the consigned inventory has been consumed, a consumption advice is generated based upon a frequency agreed upon between buyer 200 and supplier 201. The consumption advice is used to communicate to supplier 201 the consumption transactions that occurred within a specific period of time. The consumption advice can also serve as the document to initiate financial settlement for the consumed inventory. The flow then proceeds to 250. At 250, supplier 201 sends an invoice for the consumed inventory items. The flow then proceeds to 260. At 260, buyer 200 sends a payment for the invoice to supplier 201. Alternatively, the consumption advice can be used by buyer 200 to self-bill based on usage of the consigned inventory. The flow then ends. Further details of a consigned inventory process are described in application Ser. No. 14/261,501, filed Apr. 25, 2014, the contents of which are herein incorporated by reference.

In one embodiment, a consigned inventory management system is provided that allows inventory to be transferred between organizations while the inventory remains in a consigned state. The consigned inventory management system can apply one or more consumption rules to a transaction to determine whether an ownership change of one or more inventory items occurs as a result of the transaction. The consigned inventory management system can change an ownership status of the one or more inventory items only when the one or more consumption rules, when applied to the transaction, indicate that the ownership status is to change.

Interorganization transfers represent movement of inventory from one organization to another organization. Companies typically need the ability to transfer inventory between organizations while the inventory remains in a consigned state. Companies use interorganization transfers to move inventory between organizations for purposes such as inventory replenishment or replacing damaged or defective material. For example, companies will transfer inventory from one organization to another to maintain minimum inventory stocking levels. In some cases, companies will receive large quantities of consigned inventory items into a centralized receiving warehouse, where the consigned inventory items are subsequently distributed to other inventory organizations. In such cases, interorganization transfers cannot be used since the movement of the inventory items will result in consumption.

As previously described, there is a fundamental business requirement that inventory should be able to be transferred between organizations while the inventory remains in a consigned state. Previous consigned inventory systems typically have a limitation in that consigned inventory is automatically consumed when inventory is transferred from one organization to another. This ultimately results in companies not being able to transfer consigned inventory between their inventory organizations. If an organization does choose to transfer consigned inventory, there can be a significant cost impact to the organization since the system will typically automatically generate a consumption (i.e., ownership change) transaction.

Thus, according to an embodiment, a consigned inventory management system allows inventory to be transferred between organizations while the inventory remains in a consigned state. More specifically, automatic consumption of consigned inventory is based on one or more inventory consumption rules (also identified as consumption rules). A user initially defines one or more inventory consumption rules as part of an initial setup activity for consigned inventory. An inventory consumption rule compares one or more inputs from an inventory transaction with one or more specified input values to determine whether the inventory consumption rule applies to the transaction, and, if the inventory consumption rule does apply, whether consumption (i.e., ownership change) occurs. Thus, an inventory consumption rule can be configured to either indicate that an ownership change occurs as a result of the inventory transaction, or indicate that an ownership change does not occur as a result of the inventory transaction.

An input can be any attribute of an inventory transaction. For example, an inventory organization and an inventory item can be two inputs that a user can configure when defining an inventory consumption rule. The consigned inventory management system can use these inputs in order to determine if the inventory consumption rule is applicable (i.e., to determine if the inventory consumption rule indicates that the ownership of consigned inventory changes), by determine whether a value for the input is equal to a specified value.

In one embodiment, one of the inputs used by an inventory consumption rule can be a transaction type. A transaction type can be an attribute of the inventory transaction that is used to indicate a type of inventory transaction. Inventory transaction types can reflect a physical movement of inventory. For example, an inventory transaction type value, “Subinventory Transfer,” can be used to transfer inventory from an origin subinventory to a destination subinventory. A “subinventory” is a logical or physical sub-grouping of overall inventory. Further, in one embodiment, an inventory consumption rule can support inventory transaction type values, “Direct Organization Transfer” and “Intransit Shipment,” which are example values that represent interorganization transfers. When inventory consumption rules are configured for these two transactions types, an interorganization transfer can be processed automatically without triggering a consumption (i.e., ownership change) transaction. Other examples of inputs, in addition or as an alternative to a transaction type, can include: a target organization (e.g., a “from organization”), a destination organization (e.g., a “to organization”), an inventory item, or a supplier name.

FIG. 3 illustrates a flow diagram of the functionality of a consigned inventory management module (such as consigned inventory management module 16 of FIG. 1) for transferring consigned inventory from one location to another location, according to an embodiment of the invention. The flow begins and proceeds to 310. At 310, a transaction is received that is a transfer of one or more consigned inventory items between a first organization and a second organization. In certain embodiments, the first organization and the second organization can be organizations within a single business entity. The flow then proceeds to 320.

At 320, a value of an attribute of the transaction is compared with a specified attribute value. In certain embodiments, the attribute can be a transaction type. Further, in some of these embodiments, the specified attribute value can be an interorganization transfer value that indicates that the transaction is an interorganization transfer. The flow then proceeds to 330.

At 330, a consumption rule is applied to the transaction when the value of the attribute is equal to the specified attribute value. A consumption rule is a rule that indicates whether ownership changes as a result of the transaction when the rule is applied to the transaction. The flow then proceeds to 340.

At 340, ownership of the one or more consigned inventory items is transferred from the first organization to the second organization when the application of the consumption rule indicates that the ownership changes as a result of the transaction. In an embodiment, one or more ownership values that are stored within a consigned inventory management system can be automatically modified to indicate that ownership of the one or more consigned inventory items is transferred from the first organization to the second organization. The flow then proceeds to 350.

At 350, possession of the consigned inventory items is transferred from the first organization to the second organization. In an embodiment, one or more possession values that are stored within a consigned inventory management system can be automatically modified to indicate that possession of the one or more consigned inventory items is transferred from the first organization to the second organization. The flow then ends.

Thus, a consigned inventory management system can allow users to transfer inventory between organizations without having to take ownership of consigned inventory. In previous systems, users typically did not have this flexibility since interorganization transfers of consigned inventory always resulted in consumption (i.e., ownership change) of the consigned inventory. Thus, the consigned inventory management system provides cost advantages and business benefits as compared to previous systems. More specifically, the consigned inventory management system can provide a reduction in inventory carrying costs since consigned inventory can be transferred between organizations without taking ownership. Further, the consigned inventory management system can eliminate costly ad-hoc customizations used to support transferring consigned inventory between organizations.

In another embodiment, a consigned inventory management system is provided that allows users to transfer owned inventory to a consigned status without having to manually identify an original consumption transaction (or original consumption transactions) that triggered the ownership change. Instead, the consigned inventory management system can automatically identify and reverse the original consumption transaction (or original consumption transactions) to return an associated quantity of the owned inventory to a consigned status.

A consigned inventory management system can provide one or more transaction types, where a transaction type can identify a transaction that transfers ownership of inventory. For example, a “transfer to consigned” transaction type can identify a type of transaction that allows users to transfer ownership of inventory from an owned status to a consigned status, such as to transfer ownership of inventory from an internal organization to a supplier. This transaction type can be used in cases where consigned inventory is consumed in error. For example, inventory issued to a manufacturing job can exceed a quantity that is actually necessary to perform a job. Rather than taking ownership of the consigned inventory, a user can transfer owned inventory back to a consigned status. This type of transaction can be identified as a “transfer to consigned” transaction. A “transfer to consigned” transaction can also be identified as a consumption transaction.

As another example, a “transfer to owned” transaction type can identify a type of transaction that allows users to transfer ownership of inventory from a consigned status to an owned status. For example, consigned inventory can near its aging limit, and a user may need to transfer the material from a consigned status to an owned status. This type of transaction can be identified as a “transfer to owned” transaction. A “transfer to owned” transaction can also be identified as a consumption transaction.

Unique user interfaces can be designed for each transaction type. Further, transactions of both transaction types can occur either explicitly or implicitly. Explicit transactions can be performed when a user explicitly specifies an owning party to where an ownership should be transferred. Implicit transactions can occur as a result of an inventory transaction. For example, an inventory transaction type “subinventory transfer” can trigger implicit consumption.

Previous consigned inventory systems typically require a user to manually identify and reverse original consumption transactions that consumed the consigned inventory in order to return the inventory to a consigned status. For example, if a user wants to transfer owned inventory to a consigned status, the user must typically identify one or more original consumption transactions (such as “issue to WIP” transactions) that originally consumed the consigned inventory, and manually reverse the one or more consumption transactions. This process can be both time consuming and problematic. Identification of the one or more original consumption transactions may require the user to access a paper-based transaction history since the user may not have visibility to the one or more original consumption transactions that consumed the consigned inventory.

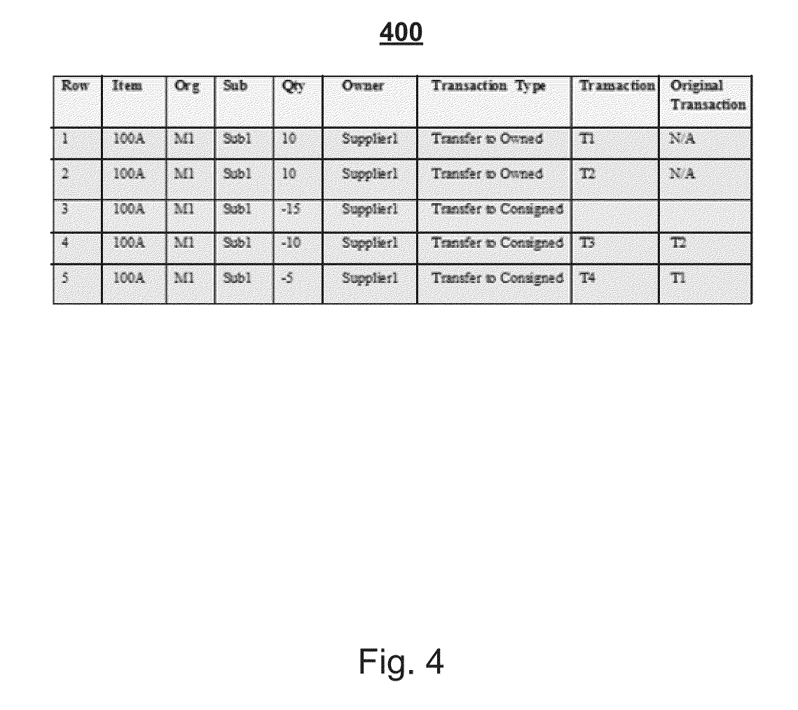

Thus, according to an embodiment, a consigned inventory management system allows users to transfer owned inventory to a consigned status without having to manually identify an original consumption transaction (or original consumption transactions) that triggered the ownership change. Instead, the consigned inventory management system can automatically identify and reverse the original consumption transaction (or original consumption transactions). In order to automatically identify and reverse the original consumption transaction, the consigned inventory management system can use programmable logic (such as one or more computer-readable instructions) to identify the original consumption transaction and return the associated quantity of the inventory to a consigned status. An example of such programmable logic is further described in greater detail in conjunction with FIG. 4.

FIG. 4 illustrates a table 400 that includes “transfer to owned” transactions and corresponding “transfer to consigned” transactions, according to an embodiment of the invention. Rows 1 and 2 of table 400 represent two “transfer to owned” transactions that occurred for a quantity of 10 for each row. These “transfer to owned” transactions are also identified as consumption transactions. These two rows are represented as transactions T1 and T2. Row 3 of table 400 represents a “transfer to consigned” transaction that occurred after transactions T1 and T2, for a quantity of −15. Since row 3 is for a quantity of −15, multiple original consumption transactions must be identified to fulfill the entire “transfer to consigned” quantity of −15. According to the embodiment, the consigned inventory management system can automatically identify the original consumption transactions within table 400. For example, the consigned inventory management system can use one or more attributes of the original consumption transactions (such as an inventory item, an organization, or a supplier) to automatically select the eligible consumption transactions from table 400. Further, the programmable logic can allocate the selected consumption transactions in a last-in-first-out (“LIFO”) manner, reversing the selected consumption transactions that occurred most recently. The most recent eligible consumption transactions can be selected in sequence until the entire “transfer to consigned” quantity is exhausted. Row 4 of table 400 represents a reversal of original transaction T2 for the quantity of 10. Row 5 of table 400 represents a reversal of original transaction T1 for a quantity of 5.

According to an embodiment, two constraints can be checked for a successful processing of a “transfer to consigned” transaction. The first constraint can be that the quantity of the inventory must be owned and available “on-hand” within the organization. The second constraint can be that the same quantity of the inventory being transferred to a consigned status must have previously been in a consigned status. This can be verified by identifying previous consumption transactions.

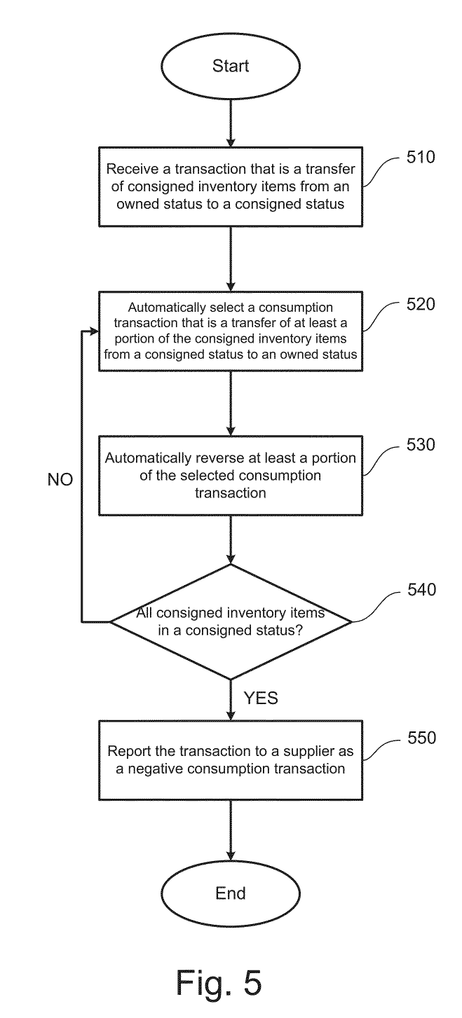

FIG. 5 illustrates a flow diagram of the functionality of a consigned inventory management module (such as consigned inventory management module 16 of FIG. 1) for returning goods to a consigned status, according to another embodiment of the invention. The flow begins and proceeds to 510. At 510, a transaction is received that is a transfer of one or more consigned inventory items from an owned status to a consigned status (i.e., a “transfer to consigned” transaction). The flow then proceeds to 520.

At 520, a consumption transaction that is a transfer of at least a portion of the consigned inventory items from a consigned status to an owned status (i.e., a “transfer to owned” transaction) is automatically selected. In certain embodiments, one or more attributes of the consumption transaction can be used to automatically select the consumption transaction. In some of these embodiments, the one or more attributes can include at least one of: an inventory item, an organization, or a supplier. The flow then proceeds to 530.

At 530, at least a portion of the selected consumption transaction is automatically reversed. In certain embodiments, where a quantity of the one or more consigned inventory items that are to be transferred to a consigned status is less than a quantity of consigned inventory items of the selected consumption transaction, a portion of the selected consumption transaction that includes a quantity of consigned inventory items of the selected consumption transaction that is equal to the quantity of the one or more consigned inventory items that are to be transferred to a consigned status is reversed. In these embodiments, where the quantity of the one or more consigned inventory items that are to be transferred to a consigned status is greater than or equal to a quantity of consigned inventory items of the selected consumption transaction, the entire selected consumption transaction is reversed. Further, in certain embodiments, by reversing the selected consumption transaction, a corresponding “transfer to consigned” transaction is generated that transfers a quantity of consigned inventory items of the selected consumption transaction to a consigned status. The flow then proceeds to 540.

At 540, it is determined whether all of the one or more consigned inventory items have been transferred to a consigned status. In some embodiments, a quantity of the one or more consigned inventory items that are to be transferred to a consigned status is compared with a quantity of consigned inventory items that have been transferred to a consigned status. If all of the one or more consigned inventory items have been transferred to a consigned status, the flow proceeds to 550. If all of the one or more consigned inventory items have not been transferred to a consigned status, the flow loops back to 520.

At 550, the transaction that is a transfer of the one or more consigned inventory items from an owned status to a consigned status is reported to a supplier as a negative consumption transaction. The flow then ends.

Thus, a consigned inventory management system can enable users to transfer owned inventory back to a consigned status in an efficient matter. The consigned inventory management system can automatically identify an original consumption transaction, and can reduce errors by eliminating a need for users to manually identify the transaction.

In another embodiment, a consigned inventory management system is provided that models a consumption advice as a separate and distinct document and data model object that can reference a receipt, consignment order, and consignment agreement. Further, the consumption advice can reference an invoice for supplier billing purposes.

Reporting consumption of consigned inventory to suppliers in an accurate and timely manner is important to maintaining a strong working relationship between a buyer and a supplier. A consumption advice serves as a mechanism to communicate consumption transactions to the supplier. A consigned inventory management system can include an executable batch program (i.e., a consumption advice creation program) that consolidates consumption transactions and includes details such as inventory item, consumed quantity, price, transaction type, and supplier information. A consignment agreement will typically define the consignment terms of the agreement, such as a consumption advice frequency and a consumption advice summary. Consumption transactions can be consolidated based on programmable grouping logic and reported to a supplier on an agreed-upon consumption advice frequency (e.g., daily, weekly, or monthly). Further, the consumption advice can use the consignment terms specified on the consignment agreement to determine a frequency of generation and consumption advice summary levels. Additionally, the consumption advice can serve as a document to initiate financial settlement with the supplier.

Previous consigned inventory systems have several limitations. First, there is typically no relationship between a blanket purchase agreement and a consignment order (modeled as an independent purchase order). In other words, in previous consigned inventory systems, the consignment order generally does not reference the blanket purchase agreement. Instead, the consignment order is generally placed on a standard purchase order, because the blanket purchase agreement is generally used for creating the consumption advice. This limitation can lead to reconciliation issues between receiving activities tracked on the consignment order and billing activities for consumption tracked on the consumption advice. Other limitations can include an inability to default consignment terms and no quantity/value checks against the blanket purchase agreement.

Second, there is typically no relationship between the consignment order (modeled as an independent purchase order) and a consumption advice (modeled as a release against a consignment agreement). The consignment order is generally used to receive consigned inventory. The consignment order typically cannot be used as the billing document since a price defined on the consignment order is provisional, and the actual price is captured at the time of consumption. Further, the consumption advice is generally modeled as a release against the blanket purchase agreement. This can result in reconciliation issues since there is no link between the consumption advice/invoice and the consignment order. This can further result in manual reconciliation of received and billed quantity for the consignment order to determine whether it has been fulfilled and can be closed.

Third, a consumption advice typically does not include lot and serial number details. As previously described, a lot is a quantity of items that are produced together and share the same production costs and specifications. As also previously described, a serial number is a unique number assigned for identification to a single item that is not repeated for similar items. When inventory is transacted, a user can specify lot and serial number details associated with the inventory items. Previous consigned inventory systems typically do not display lots and serial numbers on the consumption advice. This can be problematic since both the buyer and supplier are unable to reconcile which lot and serial numbers were consumed. Further, in previous consigned inventory systems that do not display lots and serial numbers, a user cannot enter “transfer to owned” transactions for a range of lot and serial numbers in a single transaction.

Fourth, a consumption advice can typically only be communicated to a supplier through a portal. This is because previous consigned inventory systems typically only supported display of the consumption advice via the portal. However, not all suppliers will have access to the portal. Further, there may be specific customer requirements to support a print option for the consumption advice.

Thus, according to an embodiment, a consigned inventory management system can model a consumption advice as a new document and new data model. The data model can include new database tables and database columns to support the new document. Unlike previous consigned inventory systems, the consumption advice is not modeled as a release against a blanket purchase agreement. Instead, the consumption advice is a separate document with references to a receipt, a consignment order, and a consignment agreement. Additionally, the consumption advice can reference an invoice for supplier billing purposes.

The consumption advice can include summary information. Such summary information can include: a consumption advice number; a business unit; an inventory organization; a supplier; a supplier site; a start date; and an end date. The consumption advice can be specific to a supplier and a supplier site.

The consumption advice can include one or more consumption advice lines. A consumption advice line can include one or more consumption transactions. A consumption transaction can be a “transfer to owned” transaction, where a quantity associated with the consumption transaction is positive. Further, a consumption transaction can be a “transfer to consigned” transaction, where a quantity associated with the consumption transaction is negative. When a consumption advice creation program is executed, consumption advice lines can be created by grouping consumption transactions that occurred within a billing cycle specified on a consignment agreement. The consumption transactions can be grouped by one or more specific attributes to create consumption advice lines. Attributes that can be used by a consumption advice creation program to create consumption advice lines can include: a consignment agreement; a consignment agreement line; a consignment order/consignment order line/consignment order schedule; a consumption transaction originating inventory organization; a consumption transaction item; a consumption transaction date; one or more consumption transaction financial attributes (such as a unit price, tax determinants, or a currency exchange rate/code/rate type/date); a receipt; or a receipt line. Further, based on the one or more consumption transactions, a consumption advice line can be a “transfer to owned” line or a “transfer to consigned” line.

The programmable grouping logic can be important since it can allow aggregation of consumption transactions with similar attributes. This can allow the consumption advice to be communicated to a supplier in a clear and concise format. The supplier does not have to incur a cost of reconciling large numbers of consumption transactions.

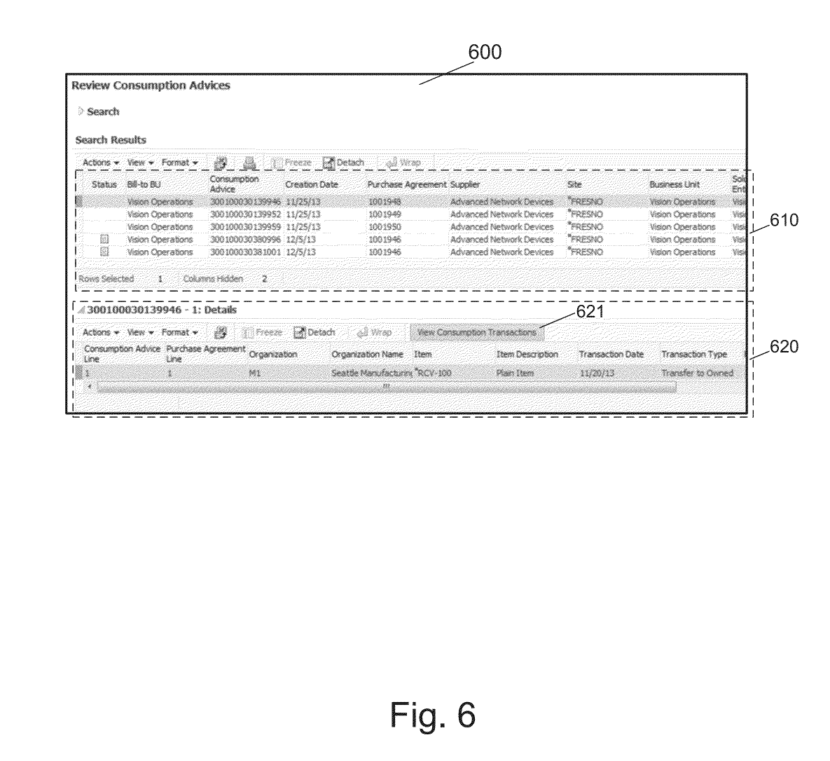

According to an embodiment, the consigned inventory management system can include a user interface that allows visibility of individual consumption transactions that contribute to a consumption advice line. Thus, a user will have the ability to view consumption transactions that are associated with a consumption advice line. For example, one consumption advice line may include five distinct consumption transactions. The user will have the capability to view each of the five consumption transactions individually. An example user interface is further described in greater detail in conjunction with FIG. 6.

According to one embodiment, the consumption advice can have complete traceability to source documents, such as a receipt, a consignment order, and a consignment agreement. The linkage between the documents can be critical to providing traceability throughout an entire consignment process. When consigned inventory is received and consumed, the receipt can be used to link back to the consignment order to update the quantities accordingly. When the consumption advice is generated, a quantity open to invoice can be updated on the consignment order.

In one embodiment, the consumption advice can store references to the following documents: (a) consignment agreement (reference can be stored on a consumption advice header); (b) consignment agreement line (reference can be stored on a consumption advice line); (c) consignment order (reference can be stored on a consumption advice line); (d) consignment order line (reference can be stored on a consumption advice line); (e) consignment order schedule (reference can be stored on a consumption advice line); (f) receipt (reference can be stored on a consumption advice line); and (g) receipt line (reference can be stored on a consumption advice line).

In an embodiment, the consumption advice can also support various summary levels. This can enable users to configure a level of granularity on the consumption advice. The consumption advice summary level can be defined on the consignment agreement. The following summary levels are supported: (a) Inventory Organization, Item, and Transaction Date (generates a single consumption advice for each unique combination of inventory organization, item, and transaction date); (b) Inventory Organization and Item (generates a single consumption advice for each unique combination of inventory organization and item); (c) Inventory Organization (generates a single consumption advice for each inventory organization); and (d) All Inventory Organizations (generates a single consumption advice across all inventory organizations).

In one embodiment, the consigned inventory management system can also display lot and serial number details on the consumption advice. The lot and serial numbers can be displayed on both a consumption advice user interface and a consumption advice report. This can allow visibility and reconciliation of consumed lots and serial numbers. Displaying lots and serial numbers can be a configurable option when creating a consumption advice, enabling users to select whether or not lot and serial number information is displayed.

Further, in an embodiment, the consigned inventory management system can also print the consumption advice. Printing a consumption advice report can be a configurable option provided to users. There can be a consumption advice report creation parameter that can allow users to indicate whether or not the consumption advice report is to be generated. If users enable the consumption advice report creation parameter, the report will be automatically created once the consumption advice is created.

FIG. 6 illustrates an example user interface 600 that displays one or more consumption advices, according to an embodiment of the invention. User interface 600 can display consumption advice summary 610, where consumption advice summary displays summary information associated with one or more consumption advices. A user can select one or more consumption advices displayed within consumption advice summary 610. User interface 600 can further display consumption advice details 620, where consumption advice details 620 displays one or more consumption advice lines associated with the one or more selected consumption advices. Consumption advice details 620 can include view consumption transactions button 621. By “clicking on,” or otherwise interfacing with consumption transactions button 621, a user can cause user interface 600 to display one or more consumption transactions that are included within a selected consumption advice line (not illustrated in FIG. 6).

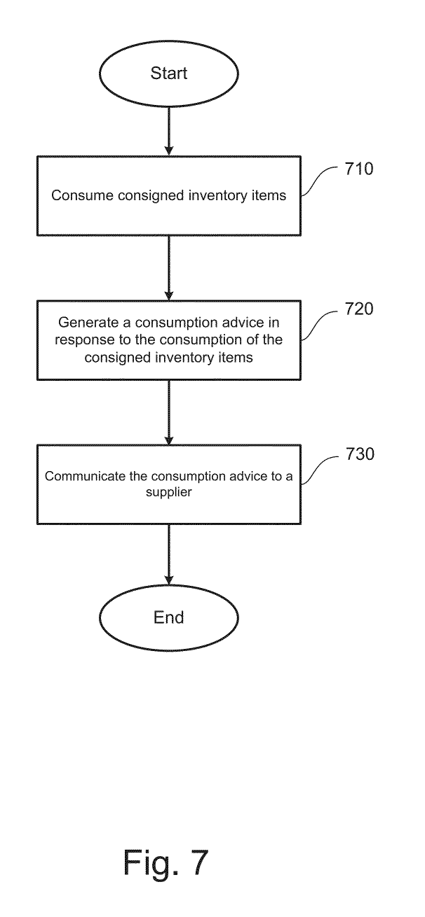

FIG. 7 illustrates a flow diagram of the functionality of a consigned inventory management module (such as consigned inventory management module 16 of FIG. 1) for consumption advice generation, according to another embodiment of the invention. The flow begins and proceeds to 710. At 710, one or more consigned inventory items are consumed. The flow then proceeds to 720.

At 720, a consumption advice is generated in response to the consumption of the one or more consigned inventory items. The consumption advice references a consignment agreement, a consignment order, and a receipt. The consignment agreement can include one or more consignment terms, one or more purchasing terms, and one or more pricing terms. The consignment order can include information regarding an order of the one or more consigned inventory items. The receipt can include information regarding a receipt of the one or more consigned inventory items. The consumption advice includes at least one of: a consumption advice number, a business unit, an inventory organization, a supplier, a supplier site, a start date, or an end date. The consumption advice further includes one or more consumption lines, where a consumption line includes one or more consumption transactions. In certain embodiments, the consumption advice further includes at least one of: a lot or a serial number. In certain embodiments, the consumption advice is generated by generating a data model object that represents a consumption advice. In certain embodiments, the consumption advice is generated by automatically creating the data model object that represents a consumption advice within a system. In some embodiments, the data model object that represents the consumption advice is stored within one or more database columns of one or more database tables. The flow then proceeds to 730.

At 730, the consumption advice is communicated to the supplier. In certain embodiments, the consumption advice can be communicated to the supplier by at least one of: automatically emailing the consumption advice; printing the consumption advice; or displaying the consumption advice within a user interface. Further, in certain embodiments, the data model object that represents the consumption advice can be transmitted to the supplier. The flow then ends.

Thus, a consigned inventory management system can model a consumption advice as a separate document and data model. This can provide many benefits, such as improved tracking and reconciliation, improved consumption advice configurability, and expanded methods of communicating consumption advices to a supplier.

More specifically, a consumption advice that is generated by the consigned inventory management system can reference both the consignment agreement and consignment order. Additionally, a consumption advice that is generated by the consigned inventory management system can be referenced by an invoice for billing purposes. From the consignment agreement to invoicing, a linkage can be maintained between all documents in a consigned inventory process flow. More specifically, the consigned inventory management system can generate a consignment agreement, a consignment order that references the consignment agreement, a consigned inventory receipt which references the consignment order, a consumption advice which references the consignment order and consignment agreement, an invoice which references the consumption advice, and a payment which references the invoice. This can improve reconciling consigned inventory.

Further, the consigned inventory management system can provide flexibility for users to configure how the consumption advice is communicated to the supplier, in light of various requirements that suppliers may have on how the consumption of consigned inventory is to be reported to the supplier. Flexible reporting periods can be supported, including daily, weekly, and monthly reporting periods. For example, suppliers having large quantities of consigned inventory may want the consumption advice to be sent on a daily basis. The consigned inventory management system can support this requirement. Further, the consigned inventory management system can generate a consumption advice using various summary levels. For example, a single consumption advice can be created for each unique combination of inventory organization, item and transaction date. This can allow a consumption advice to be tailored to specific requirements of the supplier. For example, suppliers consigning high-value inventory may want the consumption advice to be reported at a more granular level.

Additionally, the consigned inventory management system can support lot and serial numbers on a consumption advice. This can provide visibility to lot and serial numbers on both a consumption advice user interface and a consumption advice report.

Further, the consigned inventory management system can provide an ability to print and email a consumption advice to a supplier, in addition to displaying the consumption advice via a supplier portal. This provides alternatives for suppliers who do not have access, or do not use, a supplier portal, and allows these suppliers to monitor and reconcile a consigned inventory process.

In another embodiment, a consigned inventory management system is provided that allows inventory to be returned to a supplier at any point in a consignment process. A consignment line indicator is introduced allowing users to easily identify which return lines are consigned. Additionally, both consigned and non-consigned inventory can be returned to a supplier in a single transaction.

A consigned inventory return process refers to a process of returning consigned inventory to a supplier. A primary business requirement is that a buyer should be able to easily return material to a supplier at any point in the consigned inventory process. Consigned inventory can reside in various states once it has been received in to the organization. For example, consigned inventory can be received and put away into an inventory storage location. Consigned inventory can be consumed, but a consumption advice has not been generated. Consigned inventory can be consumed, and a consumption advice has been generated.

It can be critical that a buyer be able to easily return consigned inventory to a supplier at any point in the consigned inventory process flow. Not all buyers follow the same process when returning consigned inventory. Some buyers move inventory back to a consigned status, some buyers return inventory to the supplier as consigned, and some buyers return inventory to the supplier as owned. According to an embodiment, a consigned inventory management system can provide a unified process for returning consigned inventory to a supplier.

Previous consigned inventory systems typically do not allow returns to a supplier after a change in ownership transaction (prior to a consumption advice generation) has occurred when consumption is triggered by an implicit consumption transaction (such as a sales order issue or a WIP issue). Such consigned inventory systems generally do not provide functionality to clearly identify which implicit transaction to use for the return. Further, previous consigned inventory systems do not allow returns after a consumption advice has been created. Thus, in previously consigned inventory systems, only if consumption occurred as a result of an explicit transaction, can the user return the inventory to a consigned status using a “transfer to consigned” transaction. If the consumption occurred as a result of an implicit transaction, in previous consigned inventory systems, the user typically must perform a manual process (such as manually performing a miscellaneous issue from non-consigned inventory and a miscellaneous receipt into consigned inventory).

The process flow for returning consigned inventory in previous consigned inventory systems can be problematic for several reasons. Typically, inventory consumed explicitly must be returned to a consigned status before a return to supplier transaction can be performed. This can be done by creating a “transfer to consigned” transaction. There is typically a dedicated user interface that allows users to manually create a “transfer to consigned” transaction. The user must typically specify the original consumption transaction when creating a “transfer to consigned” transaction, because the original consumption transaction is generally required in order to reverse an owned quantity of consigned inventory back to a consigned status.

Identifying the original consumption transaction is typically a manual process. A user is generally required to have access to an identifier of the original consumption transaction in order to create the “transfer to consigned” transaction. In some cases, the original consumption transaction identifier may be difficult to identify. This can result in additional time spent identifying the original consumption transaction.

Another limitation is that “transfer to consigned” transactions generally cannot be created for implicit consumption. This is because a link to the originating transaction for a consigned receipt is generally lost when an implicit consumption transaction is done. Further, in order to return implicitly consumed consigned inventory, users generally need to perform a manual workaround (such as creating a miscellaneous issue of a non-consigned inventory area, and then creating a miscellaneous receipt into a consigned inventory area). This workaround is generally required in order to return the consigned inventory to a consigned status. This workaround can be both time consuming and prone to error.

Thus, in an embodiment, a consigned inventory management system can allow inventory to be returned to a supplier at any point in a consignment process. The consignment inventory management system can provide a consignment line indicator that allows users to easily identify which return lines are consigned. Additionally, both consigned and non-consigned inventory can be returned to a supplier in a single transaction.

In accordance with an embodiment, the consigned inventory management system can address the aforementioned limitations of previous consigned inventory systems by: (a) providing an easy way for the user to return inventory back to a “consigned status” without requiring the user to identify the exact transaction (implicit or explicit) that moved the inventory from a consigned status to an owned status; (b) leveraging an existing user interface to search for and process returns of consigned inventory to a supplier; (c) automatically processing a debit memorandum upon successful creation of a return transaction; and (d) automatically transferring owned inventory back to a consigned status using programmable LIFO logic to reverse the original consumption transaction. The various use cases described below explain how the consigned inventory management system can handle returns to a supplier.

In a first use case, inventory can be received but not consumed. In this first use case, an ownership of the inventory is with a supplier. In addition, in this first use case, a user can search for and return this consigned inventory. If the inventory is lot or serial controlled, the lot and serial numbers can be entered within a user interface when performing the return. The consigned inventory management system can prohibit the user from creating a debit memorandum for this return transaction since the inventory is still in a consigned status.

In a second use case, inventory can be consumed implicitly or explicitly, where a consumption advice has not been generated. In this second use case, ownership of the inventory has changed from a supplier to a buyer. However, since a consumption advice has not yet been created, the details of the ownership change have not yet been communicated to the supplier. Further, in this second use case, a user would generally prefer to return the inventory to the supplier in a consigned status rather than an owned status. In order to do this, a user first performs a “transfer to consigned” transaction for the inventory item and quantity. The “transfer to consigned” transaction can change a status of the inventory (for the quantity specified) back to a consigned status. If the inventory item is not lot or serial controlled, the consigned inventory management system can use programmable LIFO logic to identify and select the exact transaction line(s) whose status is to be changed from “owned” to “consigned.” If the inventory item is lot or serial controlled, a user can focus on a specific transaction line by providing a lot or serial numbers into a user interface when returning the inventory. Once a status of the inventory has changed from an owned status to a consigned status, the inventory is available for return to the supplier. Since ownership of the inventory has been transferred back to the supplier, it is not required to generate a debit memorandum.

In a third use case, inventory can be consumed implicitly or explicitly, where a consumption advice has been generated. In this third case, ownership of the inventory has changed from a supplier to a buyer. Since a consumption advice has been created, the details of the ownership change have been communicated to the supplier. Further, in this third use case, a user would generally return the inventory to the supplier as “owned” rather than “consigned.” Since the ownership of the inventory is with the buyer, when a “return to supplier” transaction is created, a debit memorandum is automatically generated if an invoice has been created based on the consumption advice. If the inventory item is lot or serial controlled, a user can provide a lot or serial numbers into a user interface when returning the inventory. Once a supplier receives the inventory, the supplier can process a credit note against the invoice for a corresponding consignment order line.

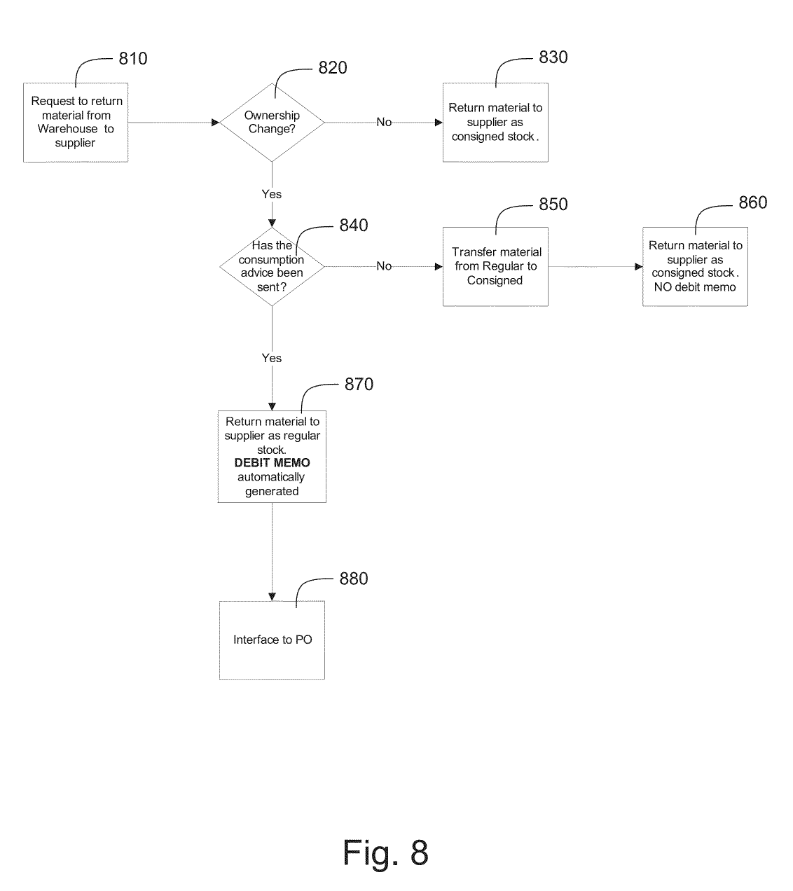

FIG. 8 illustrates a flow diagram of a consigned inventory return process flow, according to an embodiment of the invention. The flow begins and proceeds to 810. At 810, a request to return inventory to a supplier is received. This can be in response to a user inputting a request to return inventory to a supplier within a user interface. The flow then proceeds to 820. At 820, it is determined whether ownership of the inventory has changed (i.e., whether the inventory has been consumed). If ownership of the inventory has not changed, the flow proceeds to 830. If the ownership of the inventory has changed, the flow proceeds to 840. At 830, the inventory is returned to the supplier as consigned inventory. The flow then ends.

At 840, it is determined whether a consumption advice has been sent. If the consumption advice has not been sent, the flow proceeds to 850. If the consumption advice has been sent, the flow proceeds to 870. At 850, the inventory is transferred from an owned status to a consigned status. The flow then proceeds to 860. At 860, the inventory is returned to the supplier as consigned inventory. In certain embodiments, a debit memorandum is not generated. The flow then ends.

At 870, the inventory is returned to the supplier as owned inventory. In certain embodiments, a debit memorandum is automatically generated. The flow then proceeds to 880. At 880, a credit note is processed against an invoice for a consignment order line. The flow then ends.

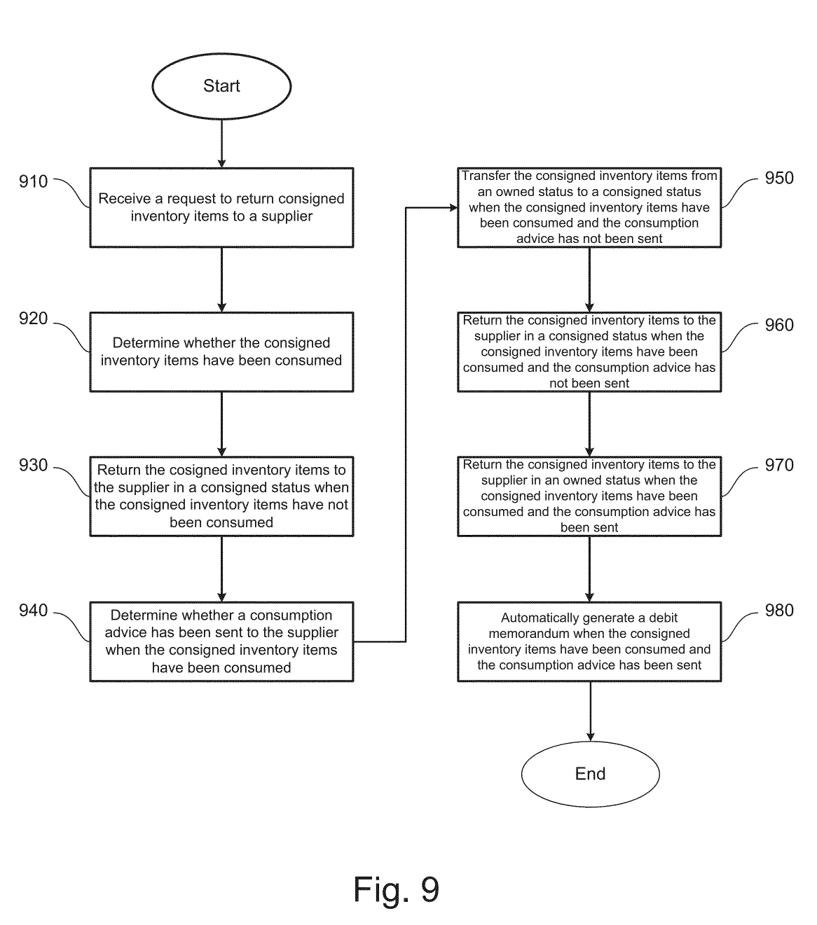

FIG. 9 illustrates a flow diagram of the functionality of a consigned inventory management module (such as consigned inventory management module 16 of FIG. 1) involving a consigned inventory return process flow, according to another embodiment of the invention. The flow begins and proceeds to 910. At 910, a request to return one or more consigned inventory items to a supplier is received. The flow then proceeds to 920. At 920, it is determined whether the one or more consigned inventory items have been consumed. The flow then proceeds to 930. At 930, the one or more consigned inventory items are returned to the supplier in a consigned status when the consigned inventory items have not been consumed. The flow then proceeds to 940. At 940, it is determined whether a consumption advice has been sent to the supplier when the one or more consigned inventory items have been consumed. The flow then proceeds to 950.

At 950, the one or more consigned inventory items are transferred from an owned status to a consigned status when the one or more consigned inventory items have been consumed and the consumption advice has not been sent. The flow then proceeds to 960. At 960, the one or more consigned inventory items are returned to the supplier in a consigned status when the one or more consigned inventory items have been consumed and the consumption advice has not been sent. The flow then proceeds to 970. At 970, the one or more consigned inventory items are returned to the supplier in an owned status when the one or more consigned inventory items have been consumed and the consumption advice has been sent. The flow then proceeds to 980. At 980, a debit memorandum is automatically generated when the one or more consigned inventory items have been consumed and the consumption advice has been sent. The flow then ends.

Thus, a consigned inventory management system can allow inventory to be returned to a supplier at any point in a consigned inventory process. This can streamline a consigned inventory return process by automating a return to supplier process, and removing manual steps from the process. The consigned inventory management system can provide an automated process to identify consigned inventory to be returned. This can allow users to return consigned inventory to suppliers in a timely and efficient manner.

In another embodiment, a consigned inventory management system is provided that identifies and records an ownership status of an inventory item during a cycle and physical inventory count process. This allows a user to consider an ownership status of an inventory item during the cycle and physical inventory count process.

Cycle counting is an inventory practice to ensure inventory accuracy in operations. Inventory accuracy helps to avoid frequency disruptions in production operations due to missing items and ensures higher level of customer satisfaction by delivering orders as planned. The frequency that organizations count items depends upon a criticality of an inventory item, a cost of the inventory item, a lead time of the inventory item, and past movements of the inventory item. Typically, an ABC classification of inventory items becomes a basis for deciding a count frequency with A class inventory items being counted more frequently than B or C class inventory items.

Physical inventory counting is a process where a business physically counts its entire inventory. A physical inventory count is performed on a periodic basis to evaluate and reconcile inventory quantities and values. A physical inventory count requires an inventory organization to suspend incoming and order fulfillment activities for the time it takes to conduct the physical inventory. It can be important to perform the required process steps sequentially and efficiently to complete the process in a timely manner. It can be equally important to provide thorough and accurate counts to correctly represent the company's financial picture. Further, in cases where organizations receive and store consigned inventory from suppliers, it can become essential to consider an ownership status of inventory items during the cycle and physical inventory count process.

In organizations that procure consigned inventory, there can be a requirement to consider a status of the inventory (i.e., a consigned status or an owned status) when performing a cycle and physical inventory count process. Previous consigned inventory systems typically do not provide this capability. Failing to consider the status of the inventory can result in an incorrect picture of inventory ownership since the complete quantity of an inventory item is reported as owned. When consigned inventory is involved in a cycle and physical inventory count process, the quantity of the consigned inventory should be reported as consigned instead of owned. This incorrect picture of inventory ownership can increase the liability of a company during financial reporting. Further, failing to consider the status of the inventory can result in an inability to perform adjustments if there are discrepancies between a physical quantity and a system quantity during the counting process. Since an owning party is generally not specified for an adjusted quantity, the quantity adjusted can be automatically considered as owned, which may not be correct when consigned inventory is involved in the cycle and physical inventory count process.

Thus, in one embodiment, a consigned inventory management system identifies and records an ownership status of an inventory item during a cycle and physical inventory count process. This allows a user to consider an ownership status of an inventory item during the cycle and physical inventory count process.

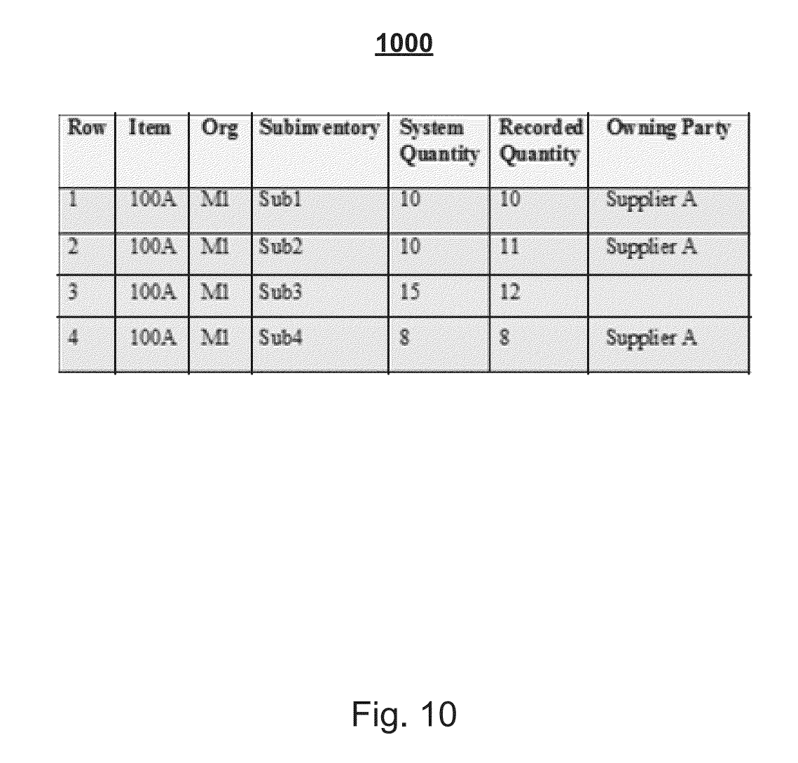

FIG. 10 illustrates a table 1000 that includes inventory items where an ownership status is indicated, according to an embodiment of the invention. Table 1000 includes rows 1, 2, 3, and 4 which illustrate inventory item counts during a cycle and physical inventory count process. As illustrated in FIG. 10, the same inventory item (“100A”) is available and stored in multiple sub-inventories.

According to the embodiment, during the cycle count process, there is a discrepancy between the system quantity and the recorded quantity in rows 2 and 3. More specifically, in row 2, for the subinventory “Sub2,” there is a system quantity of 10 and a recorded quantity of 11. Further, in row 3, for the subinventory “Sub3,” there is a system quantity of 15 and a recorded quantity of 12. Thus, the subinventory “Sub2” requires a positive quantity adjustment, whereas the subinventory “Sub3” requires a negative quantity adjustment. However, any adjustment without considering an ownership status of an inventory item (i.e., an owned status vs. a consigned status) has the potential of incorrectly increasing or decreasing an organization's financial liability. Thus, in accordance with the embodiment, table 1000 also identifies, records, and indicates an owning party for the inventory indicated in each row. More specifically, rows 1, 2, and 4 indicate that the inventory is owned by a supplier (i.e., “Supplier A”) within an “Owning Party” column of table 1000, and row 3 indicates that the inventory is owned by a buyer (i.e., a blank value) within the “Owning Party” column of table 1000. Thus, according to the embodiment, an adjustment transaction will increase an item quantity of consigned inventory in subinventory “Sub2” belonging to the supplier, and will decrease an item quantity of owned inventory in subinventory “Sub3” belonging to the buyer. By indicating an ownership status and owning party of each inventory item, a user (e.g., a warehouse manager) can be assisted in making a decision on whether to proceed with correcting the item quantity in row 2 for subinventory “Sub2.”

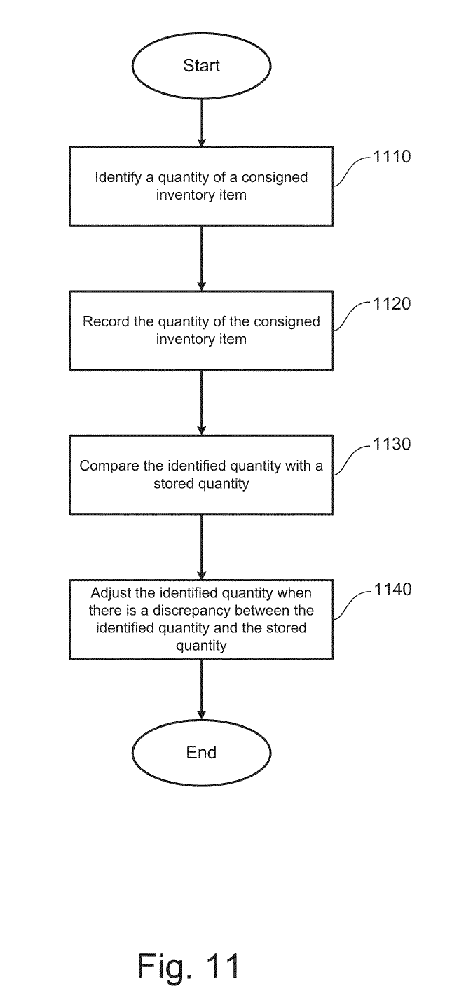

FIG. 11 illustrates a flow diagram of the functionality of a consigned inventory management module (such as consigned inventory management module 16 of FIG. 1) for counting consigned inventory, according to another embodiment of the invention. The flow begins and proceeds to 1110. At 1110, a quantity of one or more consigned inventory items is identified. The flow proceeds to 1120. At 1120, the quantity of the one or more consigned inventory items is recorded. The flow proceeds to 1130. At 1130, the identified quantity is compared with a stored quantity. The flow proceeds to 1140. At 1140, the identified quantity is adjusted when there is a discrepancy between the identified quantity and the stored quantity. The flow then ends.

Thus, a consigned inventory management system can provide an ability to recognize an owning party during a cycle and physical inventory counting process. This can improve inventory accuracy and allow a company to correctly report financial liability.

Thus, a consigned inventory management system can provide for: (a) transferring inventory between organizations while the inventory remains in a consigned status; (b) automatic transferring owned inventory to a consigned status; (c) automatically generating and managing a consumption advice document; (d) returning consigned inventory to a supplier at any point in a consignment process; and (e) identifying and recording an ownership status of inventory during a cycle and physical inventory count process. Business uptake of consigned inventory from suppliers has been limited due to a lack of standard software solutions. Previous consigned inventory systems have not met companies' requirements for an automated process which can be reconciled at a financial period close, or auditors' requirements that all stored inventory, including consigned inventory, is counted at least once per year. The consigned inventory management system addresses many of the aforementioned limitations of previous consigned inventory systems. The consigned inventory management system can further enable wide adoption of automated consignment inventory management processes among users in the relevant marketplaces.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to manage consigned inventory, the managing comprising:
consuming at least one consigned inventory item;
generating a data model object that represents a consumption advice in response to the consumption of the at least one consigned inventory item, wherein the data model object that represents the consumption advice references a consignment agreement, a consignment order and a receipt;
storing the data model object that represents the consumption advice within one or more database columns of one or more database tables; and
communicating the consumption advice to a supplier, wherein the communicating further comprises transmitting the data model object that represents the consumption advice to the supplier;
wherein the consumption advice comprises at least one of: a consumption advice number; a business unit; an inventory organization; a supplier; a supplier site; a start date; or an end date;
wherein the consumption advice comprises one or more consumption advice lines; and
wherein a consumption advice line comprises a consumption transaction.

2. The computer-readable medium of claim 1,
wherein the consumption advice further comprises at least one of: a lot; or a serial number.

3. The computer-readable medium of claim 1,
wherein the consignment agreement comprises one or more consignment terms and one or more purchasing terms;
wherein the consignment order comprises information regarding an order of the at least one consigned inventory item; and
wherein the receipt comprises information regarding a receipt of the at least one consigned inventory item.

4. The computer-readable medium of claim 1, wherein communicating the consumption advice to the supplier comprises at least one of: automatically emailing the consumption advice; printing the consumption advice; or displaying the consumption advice within a user interface.

5. The computer-readable medium of claim 1, the managing further comprising:
receiving a transaction comprising a transfer of at least one consigned inventory item between a first organization and a second organization;
comparing a value of an attribute of the transaction with a specified attribute value;
applying a consumption rule to the transaction when the value of the attribute is equal to the specified attribute value;
transferring ownership of the at least one consigned inventory item from the first organization to the second organization when the application of the consumption rule indicates that the ownership of the at least one consigned inventory item changes as a result of the transaction; and
transferring possession of the at least one consigned inventory item from the first organization to the second organization.

6. The computer-readable medium of claim 5, wherein the attribute comprises a transaction type.

7. The computer-readable medium of claim 6, wherein the specified attribute value comprises an interorganization transfer value.

8. The computer-readable medium of claim 5, wherein the first organization and the second organization comprise organizations within a single business entity.

9. The computer-readable medium of claim 1, the managing further comprising:
receiving a transaction comprising a transfer of at least one consigned inventory item from an owned status to a consigned status;
automatically selecting one or more consumption transactions, wherein each selected consumption transaction comprises a transfer of at least a portion of the at least one consigned inventory item from a consigned status to an owned status;
automatically reversing at least a portion of each selected consumption transaction; and
reporting the transaction to a supplier as a negative consumption transaction.

10. The computer-readable medium of claim 1, the managing further comprising:
receiving a request to return at least one consigned inventory item to a supplier;
determining whether the at least one consigned inventory item has been consumed; and
returning the at least one consigned inventory item to the supplier in a consigned status when the at least one consigned inventory item has not been consumed.

11. The computer-readable medium of claim 10, the managing further comprising:
determining whether a consumption advice has been sent to a supplier when the at least one consigned inventory item has been consumed;
transferring the at least one consigned inventory item from an owned status to a consigned status when the at least one consigned inventory item has been consumed and the consumption advice has not been sent; and
returning the at least one consigned inventory item to the supplier in a consigned status when the at least one consigned inventory item has been consumed and the consumption advice has not been sent.

12. The computer-readable medium of claim 11, the managing further comprising:
returning the at least one consigned inventory item to the supplier in an owned status when the at least one consigned inventory item has been consumed and the consumption advice has been sent; and
automatically generating a debit memorandum when the at least one consigned inventory item has been consumed and the consumption advice has been sent.

13. The computer-readable medium of claim 1, the managing further comprising:
identifying a quantity of at least one consigned inventory item;
recording the identified quantity of the at least one consigned inventory item;
comparing the identified quantity with a stored quantity; and
adjusting the identified quantity when there is a discrepancy between the identified quantity and the stored quantity.

14. The computer-readable medium of claim 1,
wherein the generating the data model object that represents the consumption advice further comprises automatically creating the data model object that represents the consumption advice within a system.

15. A computer-implemented method for managing consigned inventory, the computer-implemented method comprising:
consuming at least one consigned inventory item;
generating a consumption advice in response to the consumption of the at least one consigned inventory item, wherein the consumption advice references a consignment agreement, a consignment order and a receipt; and
communicating the consumption advice to a supplier;
wherein the consumption advice comprises at least one of: a consumption advice number; a business unit; an inventory organization; a supplier; a supplier site; a start date; or an end date;
wherein the consumption advice comprises one or more consumption advice lines; and
wherein a consumption advice line comprises a consumption transaction.

16. The computer-implemented method of claim 15, further comprising:
receiving a transaction comprising a transfer of at least one consigned inventory item between a first organization and a second organization;
comparing a value of an attribute of the transaction with a specified attribute value;
applying a consumption rule to the transaction when the value of the attribute is equal to the specified attribute value;
transferring ownership of the at least one consigned inventory item from the first organization to the second organization when the application of the consumption rule indicates that the ownership of the at least one consigned inventory item changes as a result of the transaction; and
transferring possession of the at least one consigned inventory item from the first organization to the second organization.

17. The computer-implemented method of claim 15, further comprising:
receiving a transaction comprising a transfer of at least one consigned inventory item from an owned status to a consigned status;
automatically selecting one or more consumption transactions, wherein each selected consumption transaction comprises a transfer of at least a portion of the at least one consigned inventory item from a consigned status to an owned status;
automatically reversing at least a portion of each selected consumption transaction; and
reporting the transaction to a supplier as a negative consumption transaction.

18. A system for managing consigned inventory, the system comprising:
a consumption module configured to consume at least one consigned inventory item;
a consumption advice generation module configured to generate a consumption advice in response to the consumption of the at least one consigned inventory item, wherein the consumption advice references a consignment agreement, a consignment order and a receipt; and
a communication module configured to communicate the consumption advice to a supplier;
wherein the consumption advice comprises at least one of: a consumption advice number; a business unit; an inventory organization; a supplier; a supplier site; a start date; or an end date;
wherein the consumption advice comprises one or more consumption advice lines; and
wherein a consumption advice line comprises a consumption transaction.

19. The system of claim 18, further comprising:
a transaction reception module configured to receive a transaction comprising a transfer of at least one consigned inventory item between a first organization and a second organization;
a value comparison module configured to compare a value of an attribute of the transaction with a specified attribute value;
a consumption rule module configured to apply a consumption rule to the transaction when the value of the attribute is equal to the specified attribute value;
an ownership transfer module configured to transfer ownership of the at least one consigned inventory item from the first organization to the second organization when the application of the consumption rule indicates that the ownership of the at least one consigned inventory item changes as a result of the transaction; and
a possession transfer module configured to transfer possession of the at least one consigned inventory item from the first organization to the second organization.

20. The system of claim 18,
wherein the transaction reception module is further configured to receive a transaction comprising a transfer of at least one consigned inventory item from an owned status to a consigned status;
the system further comprising:
an automatic selection module configured to automatically select one or more consumption transactions, wherein each selected consumption transaction comprises a transfer of at least a portion of the at least one consigned inventory item from a consigned status to an owned status;
an automatic reversal module configured to automatically reverse at least a portion of each selected consumption transaction; and
a transaction reporting module configured to report the transaction to a supplier as a negative consumption transaction.
